(19) United States
(12) Patent Application Publication
(10) Pub. No.: US 2004/0113451 A1
(43) Pub. Date: Jun. 17, 2004

(54) Stowable seat assembly

(76) Inventors: Maciej Szymanski, Poznan (PL); Christian Hammarskjold, Berwyn, PA (US); David G. Kiernan, Coatesville, PA (US)

Correspondence Address: Miller, Canfield, Paddock and Stone P.L.C., c/o Robert Kelley Roth, Suite 2500, 150 West Jefferson Ave, Detroit, MI, 48226, US

(21) Appl. No.: 10/730,562

(22) Filed: Dec. 8, 2003

Related U.S. Application Data
(60) Provisional application No. 60/431,541, filed on Dec. 6, 2002.

(51) Int. Cl. B60N 2/04

(52) U.S. Cl. 296/65.05

(57) ABSTRACT

A stowable seat assembly for a vehicle comprises a seat having a seat back and a seat base pivotable with respect to the seat back, wherein the seat is movable between a normal position, a first stowed position and a second stowed position. The seat moves forward with respect to the vehicle to move the seat from the normal position to the first stowed position, and the seat pivots about ninety degrees with respect to the vehicle to move the seat from the first stowed position to the second stowed position. A frame mounts the seat and a link cooperates with the frame to connect the seat to the vehicle.

### RELATED APPLICATION

This application claims priority benefit of U.S. provisional patent application No. 60/431,541 filed on Dec. 6, 2002.

### FIELD OF THE INVENTION

This invention relates to a stowable seat assembly and more particularly, to a stowable seat assembly suitable for use on mass transportation vehicles.

### BACKGROUND OF THE INVENTION

Seats used in mass transportation vehicles sometimes need to be movable to a position which increases available floor space and allows insertion of other items, such as a wheelchair. Known stowable seat assemblies typically fall into several categories including: transverse flip seats, longitudinal flip seats and “ironing board” seats. With transverse and longitudinal flip seats the seat is fixed to the vehicle and a seat base can be pivoted up against a seat back. This allows for some increase in the amount of floor space. With ironing board seats, the seat back folds down and the seat base and seat back together fold up against the wall. Although such designs increase available floor space, they are disadvantageous in that the seat backs are not as strong as they could be since they are foldable. That is, the strength of the seat back depends solely on the pivot and locking mechanism. Further, ironboard seats stand out from a vehicle wall a substantial distance when folded, consuming valuable floor space and partially obscuring and hindering the view of passengers seated in the vehicle. It would be desirable to provide a stowable seat assembly which increases floor space while maintaining seat strength and avoiding problems associated with obscured and hindered views.

### SUMMARY OF THE INVENTION

In accordance with a first aspect, a stowable seat assembly for a vehicle comprises a seat having a seat back and a seat base pivotable with respect to the seat back and a support which supports the seat and connects the seat to a wall or a floor of the vehicle. The seat is movable between a normal position, a first stowed position or a second stowed position. The seat moves forward with respect to the vehicle to move the seat from the normal position to the first stowed position and the seat pivots about ninety degrees with respect to the vehicle to move the seat to the second stowed position. The support can comprise a frame and a link which allow relative movement between one another during movement of the stowable seat assembly.

From the foregoing disclosure and the following more detailed description of various preferred embodiments it will be apparent to those skilled in the art that the present invention provides a significant advance in the technology and art of seat assembles. Particularly significant in this regard is the potential the invention affords for providing a high quality, low cost, stowable seat assembly. Additional features and advantages of various preferred embodiments will be better understood in view of the detailed description provided below.

### BRIEF DESCRIPTION OF THE DRAWINGS

FIG. 1 is a top view of a stowable seat assembly in accordance with a preferred embodiment, showing rows of seats in a normal position.

FIG. 2 is a top view of the stowable seat assembly of FIG. 1 showing a middle row of seats in a first stowable position and a rear row of seats in a second stowable position.

FIG. 3 is a top view of the stowable seat assembly of FIG. 1, showing the back row in the first stowable position.

FIG. 4 is a top view of the stowable seat assembly of FIG. 1, showing the back row of seats in the second stowable position with the seat base down.

FIG. 5 is an exploded perspective view showing the seat back pivoted up against the seat base.

FIG. 6 is an exploded perspective view showing the frame which supports the seats.

FIG. 7 is a side view of a row of seating of the stowable seat assembly of FIG. 1.

FIG. 8 is a front view of the row of seating in FIG. 7, showing a pair of latches.

FIG. 9 is a perspective view from underneath the frame of a preferred embodiment of a latch assembly securing the seat to the motor vehicle, shown in an unlatched position.

FIG. 10 is a perspective view of the latch assembly of FIG. 9, shown in a latched position.

It should be understood that the appended drawings are not necessarily to scale, presenting a somewhat simplified representation of various preferred features illustrative of the basic principles of the invention. The specific design features of the stowable seat assembly as disclosed here will be determined in part by the particular intended application and use environment. Certain features of the illustrated embodiments have been enlarged or distorted relative to others to facilitate visualization and clear understanding. In particular, thin features may be thickened, for example, for clarity of illustration. All references to direction and position, unless otherwise indicated, refer to the orientation illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and design variations are possible for the stowable seat assembly disclosed here. The following detailed discussion of various alternative and preferred features and embodiments will illustrate the general principles of the invention with reference to a stowable seat assembly suitable for use in mass transportation vehicles, most particularly buses and vans. Other embodiments suitable for other applications will be apparent to those skilled in the art given the benefit of this disclosure.

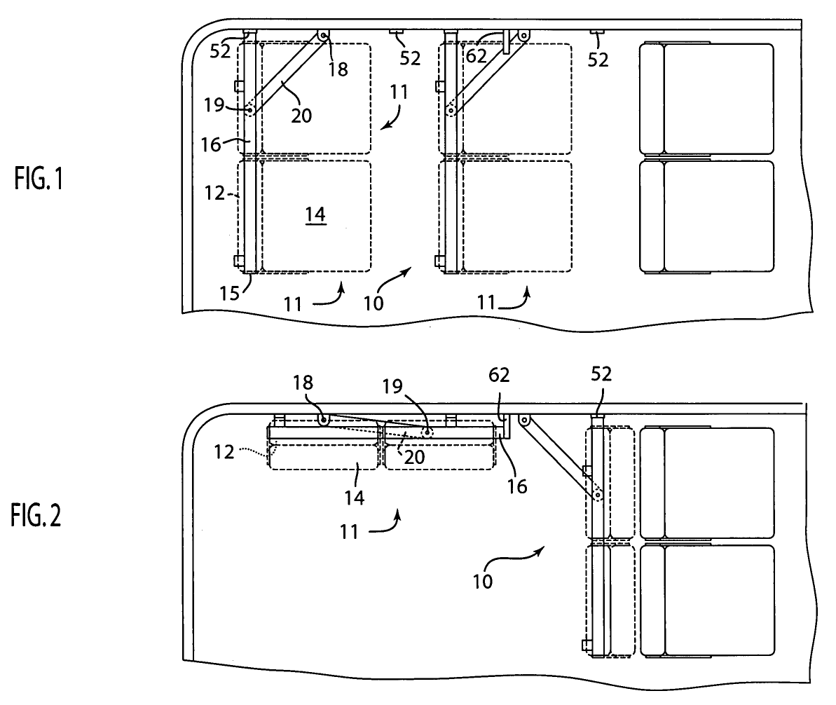

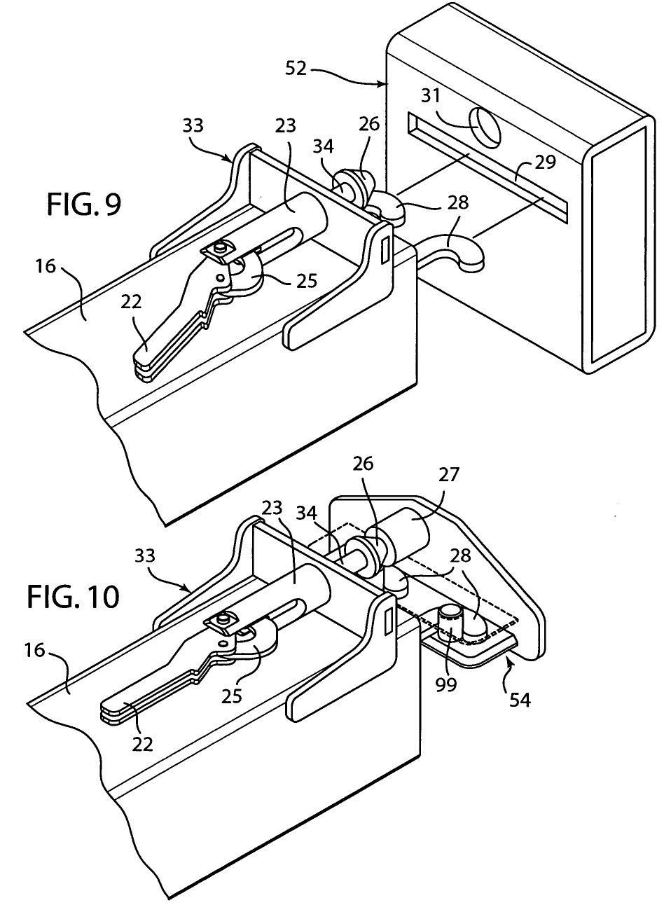

FIG. 1 shows three rows of a stowable seat assembly 10 shown in a normal position facing forward. Each row comprises a seat 11 having a seat back 12 and a seat base 14. The seat base and seat back may be provided with cushioning to enhance user comfort. The seat base is mounted to a frame 16 which cooperates with a link 20 to connect to a wall 13 of the vehicle. FIG. 2 shows the first row of seats on the far right maintained in the normal position, the second rows of seats moved forward to a first stowed position and a third row of seats on the far left pivots about ninety degrees to a second stowed position. Moving the seat 11 between the normal position and either of the stowed positions involves disengaging the latch assembly (discussed below and shown in greater detail at FIGS. 9-10), moving the seat and then reengaging the latch assembly. Preferably the seat base 14 is rigidly connected to the frame Once the latch assembly is disengaged, the frame 16 and seat 11 are free to pivot with respect to the link and the link can pivot with respect to the wall. Movement of the seat from the normal position to the first stowed position involves pivotal movement of the link 20 about main pivot 18 (counterclockwise as viewed in FIGS. 1-4) and pivotal movement of the frame 16 and seat with respect to the link compensating for the movement of the link so as to maintain the seat generally parallel to the rows of seating in front and behind. This advantageously increases available floor space without blocking views by users of other seats.

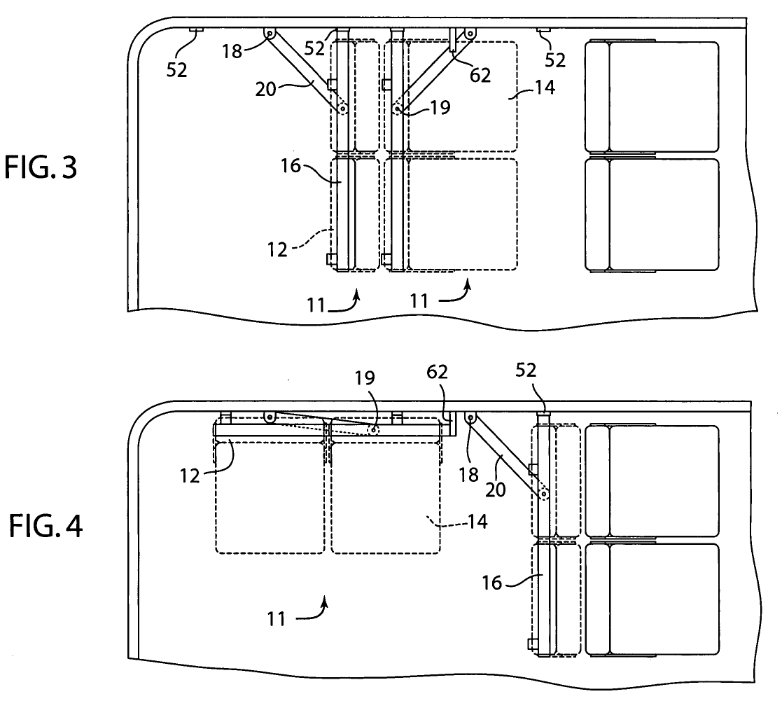

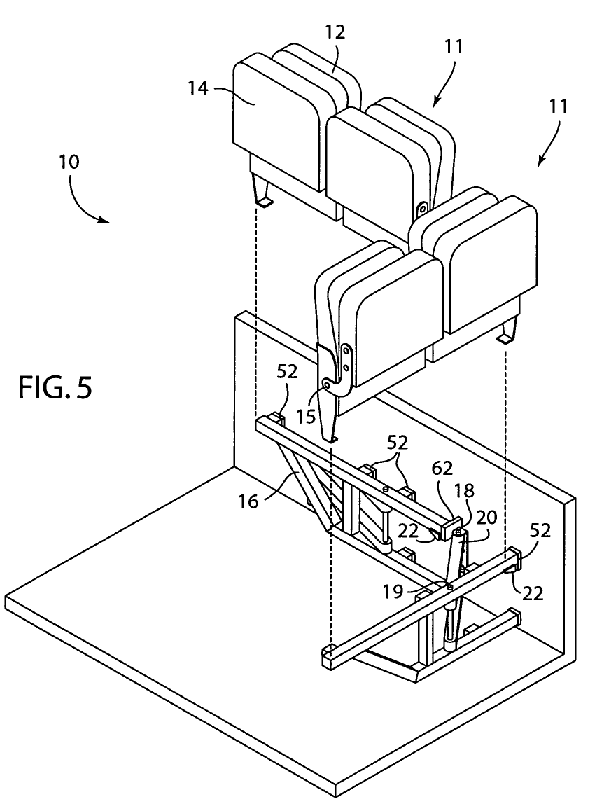

FIG. 3 shows how the third row may be moved forward from the normal position to the first stowed position. The seat base 14 is pivoted up so as to allow the seat to be moved forward close to the row of seats in front. In the preferred embodiments shown in the drawings, a row of seats in front must be moved to the first stowed position to allow the row of seats behind to be moved to the second stowed position. As shown in FIG. 4, the second row of seats is in the first stowed position. The third row of seats has the link 20 pivoted forward about the main pivot 18 (again in a direction counterclockwise as shown looking down from the view in FIG. 4) but the seat 11 and frame 16 pivot about frame pivot 19 so that the seat faces inward away from the wall 13.

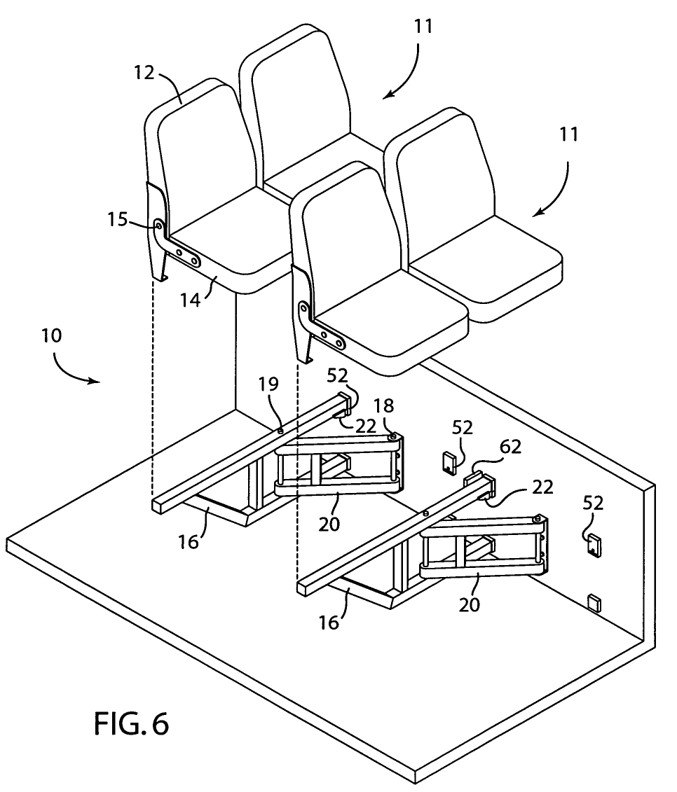

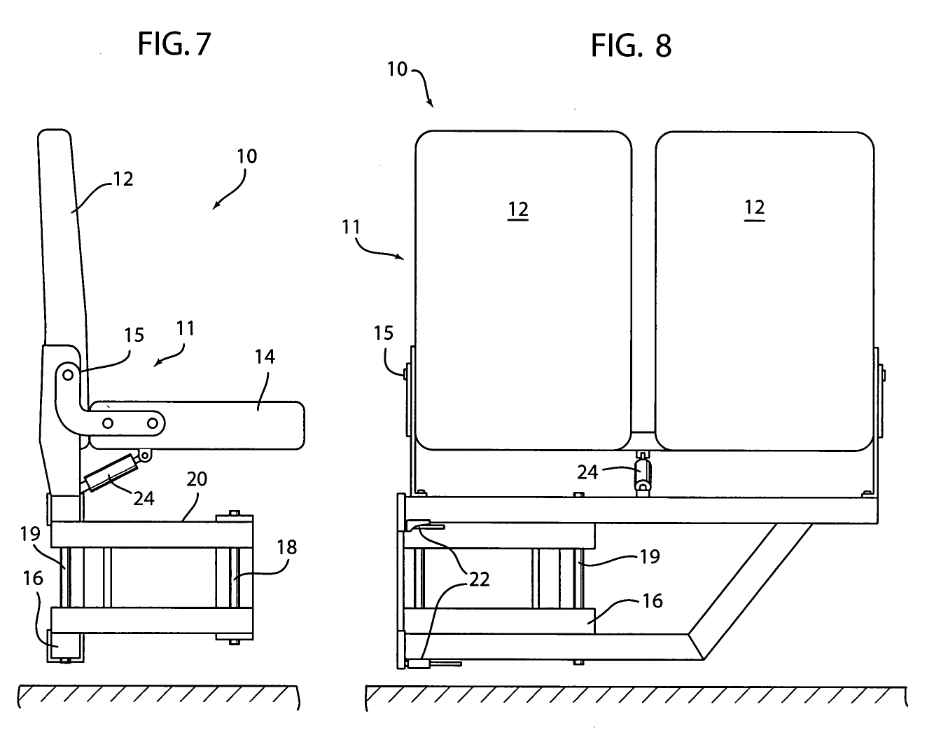

FIGS. 5 and 6 show exploded perspective views of the stowable seat assembly 10, showing the seat base 14 being pivotable with respect to the seat back 12 about a seat pivot 15 between an up position (FIG. 5) and a down position (FIG. 6) where the seat base 14 is generally perpendicular with respect to the seat back 12, in accordance with a highly advantageous feature. Preferably a gas shock 24 is used with the seat base (seen in FIGS. 7-8). The gas shock 24 works to resist movement of the seat base 14 from the down position and to resist movement of the seat base from the up position until it overcomes a center point. Thus, the effect of the gas shock is to increase the tendency of the seat base to stay in whatever position it is in currently.

FIGS. 9-10 show a preferred embodiment of a latch assembly. A latch attachment bracket 33 is attached to the underside of the frame 19, and supports a rod 34. The rod is slidable in a bore in the latch attachment bracket 33 in response to rotation of a latch 22 mounted on a bored tube 23. Rotation of the latch 22 rotates a cam 25 which urges the rod 34 to slide back and forth. J-hooks 28 extend from the side of the frame 16 and are insertable through an opening 29 to engage mounting bolts 99 positioned on a mounting plate 54 of a wall attachment bracket 52. The rod 34 has a cone shaped end 26 which extends into an opening 31 of the wall attachment bracket 52 to engage a stop 27.

In the locked or latching position shown in FIG. 10, the cone 26 engages the stop 27 in tension and the J-hooks 28 engage the mounting bolts 99 to hold the rows of seats to the vehicle wall. In the unlocked or unlatched position shown in FIG. 9 the latch 22 is pivoted, which in turn rotates the cam 25, allowing the rod to move away from the wall attachment bracket. Once this is accomplished, the seat 11 may the be moved away from the wall as discussed above and the J-hooks 28 are permitted to separate from the mounting bolts 99. Preferably a pair of tensioning latches 22 may be used, one above the other, as shown in FIG. 8.

The wall attachment bracket 52 shown in FIGS. 9 and 10 is mounted on the wall 13 and faces the frame 16 so as to engage the J-hooks 28 and cone 26 when the seat is in the normal position. As best shown in FIGS. 1-4, another or second wall attachment bracket 52 is mounted on the wall 13 at a position to permit latching of the seat in the first stowed position. However, the frame 16 rotates about 90 degrees when the seat is moved from the normal position to the second stowed position. In this instance, the J-hooks 28 and rod 34 no longer face the wall 13. To compensate for this, a third wall attachment bracket 62 is provided, seen in FIGS. 1-6. Wall attachment bracket 62 preferably has the same components of the latch assembly as wall attachment bracket 52, but it will be rotated with respect to the wall 13 to align with the frame 16 when in the second stowed position, thereby advantageously allowing for latching of the stowable seat assembly to the wall in the second stowed position. Other latch assemblies suitable for use with the stowable seat assembly disclosed herein will be readily apparent to those skilled in the art given the benefit of this disclosure.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A stowable seat assembly for a vehicle comprising, in combination:
a seat having a seat back and a seat base pivotable with respect to the seat back, wherein the seat is movable between a normal position, a first stowed position and a second stowed position;
wherein the seat moves forward with respect to the vehicle to move the seat from the normal position to the first stowed position; and
wherein the seat pivots about ninety degrees with respect to the vehicle to move the seat from the first stowed position to the second stowed position.

2. The stowable seat assembly of claim 1 wherein the seat base is moveable between a down position where the seat base is generally perpendicular to the seat back and an up position, when the seat is in one of the normal position and the second stowed position.

3. The stowable seat assembly of claim 1 wherein the seat base is movable between an up position and a down position, and further comprising a gas shock attached to the seat base which resists movement from the up position and resists movement from the down position.

4. The stowable seat assembly of claim 1 wherein at the first stowed position the seat back is aligned generally parallel with the seat back at the normal position.

5. The stowable seat assembly of claim 1 further comprising a latch assembly latching the seat in one of the normal position, the first stowed position and the second stowed position.

6. The stowable seat assembly of claim 5 wherein the latch assembly comprises a first wall attachment bracket which cooperates with the frame to latch the seat in the normal position, a second wall attachment bracket which cooperates with the frame to latch the seat in the first stowed position, and a third wall attachment bracket which cooperates with the frame to latch the seat in the second stowed position.

7. The stowable seat assembly of claim 6 wherein the frame rotates about 90 degrees with respect to the vehicle when moved from the normal position to the second stowed position, and the third wall attachment bracket is rotated about 90 degrees with respect to the first wall attachment bracket.

8. A stowable seat assembly comprising, in combination:
a seat movable between a normal position and a stowable position comprising a seat back and a seat base; and
a support supporting the seat and adapted to connect the seat to a wall comprising a frame and a link;
wherein the frame pivots with respect to the link and the link pivots with respect to the wall as the seat moves from the normal position to the stowable position.

9. The stowable seat assembly of claim 8 wherein the seat has a second stowable position and the frame pivots with respect to the wall and the seat pivots with respect to the fame as the seat moves from the normal position to the second stowable position.

10. The stowable seat assembly of claim 9 wherein the seat in the normal position faces forward and in the second stowed position faces at about 90 degrees from forward.

11. The stowable seat assembly of claim 8 wherein the seat in the normal position faces forward and in the stowed position faces forward.
